(19) United States
(12) Patent Application Publication
(10) Pub. No.: US 2003/0189669 A1
(43) Pub. Date: Oct. 9, 2003

(54) Method for off-image data display

(76) Inventor: Todd S. Bowser, Yardley, PA (US)

Correspondence Address: RATNERPRESTIA, P O BOX 980, VALLEY FORGE, PA, 19482-0980, US

(21) Appl. No.: 10/117,260

(22) Filed: Apr. 5, 2002

(51) Int. Cl. H04N 5/445

(52) U.S. Cl. 348/564

(57) ABSTRACT

A method of providing auxiliary data on a display includes receiving a video signal, extracting from the video signal auxiliary data, and storing the extracted auxiliary data. The method also includes extracting from the video signal a video image, and storing the extracted video image. The video image is manipulated to adjust either a horizontal dimension or a vertical dimension of the image and the manipulated video image is positioned on the display. The auxiliary data are also positioned on the display adjacent to the positioned video image.

### FIELD OF THE INVENTION

The present invention relates, in general, to a method of displaying a video image and, more particularly, to a method of displaying closed caption text, auxiliary data, or other information that is received with a television video image.

### BACKGROUND OF THE INVENTION

Television signals may include auxiliary information representing information other than the video and audio program components of a television program. For example, in the United States, NTSC (National Television Standards Committee) television signals may include closed caption information. When decoded and displayed, closed captioning provides a visible text representation of a television program's audio content. Another example is subtitle information retrieved, for example, from a digital versatile disk (DVD).

The NTSC standard specifies that closed caption text data should be transmitted on scan line 21 of every odd video field of the North American interlaced video signal. Each odd video field that contains closed caption data is preceded with a 0.5035 MHz sinusoidal signal for use by the television decoder to lock to the closed caption data. A start bit immediately follows the sinusoidal signal, which is immediately followed by 16 bits of closed caption data. These bits form two 7 bit ASCII codes plus odd parity bits, forming two bytes of closed caption data. These two bytes may define text or define style and attribute information.

The bytes may also contain information to control modes of the decoder. This information may define whether the text should be shown full screen, or whether the text should be on a small portion of the screen. In addition, the information may also define whether the text should be rolled-up (scrolled), popped on (displayed all at one time), or painted-on (displayed in a continuously printing manner).

Closed caption data may also be received as a digital data stream that has been compressed and encoded. In an MPEG2 data stream, closed caption data is called “line 21 data”. The “line 21 data” is decoded by a decoder and superimposed onto line 21 of the image during the vertical blanking period of the television video signal. Conventional closed captioning methods may then be used to superimpose textual data on an action image.

Closed caption data is currently displayed over active video. When activated, the decoder decodes the closed caption data and produces a video signal containing the closed caption text which replaces part or all of a television program that is being watched. The result is that portions of the broadcast image is obscured by the closed caption text.

In DVD technology, video tracks may be supplemented with various tracks for subtitles and captions. Most DVD players allow the user to select a language and appropriate subtitles that may be automatically displayed on the screen. On letterboxed movies, subtitles may be placed in the matte area. These subtitles may be turned on or off by the viewer. The subtitles may be placed only at a fixed position in the matte area.

Furthermore, conventional closed caption text is often difficult to read against some background colors and over an active moving background that changes while the text is displayed

### SUMMARY OF THE INVENTION

To meet this and other needs, and in view of its purposes, the present invention includes a method of providing auxiliary data on a display. The method includes receiving a video signal, extracting from the video signal auxiliary data, and storing the extracted auxiliary data. The method also includes extracting from the video signal a video image, and storing the extracted video image. The video image is manipulated to adjust at least one of a horizontal dimension and a vertical dimension of the video image, and the manipulated video image is positioned on the display. The auxiliary data is also positioned on the display adjacent to the positioned video image.

In one embodiment of the invention, the method includes proportionately reducing the size of the video image in a horizontal direction of the display and in a vertical direction of the display. Also included is positioning the reduced sized image to a side of the display and positioning the auxiliary data to another side of the display. The reduced sized image may be positioned on a top side of the display and the auxiliary data may be positioned on a bottom side of the display. Alternatively, the reduced sized image may be positioned on a bottom side of the display and the auxiliary data may be positioned on a top side of the display.

In another embodiment of the invention, the method receives a video image and closed caption data, and receives an aspect ratio of the received video image. The method shrinks the video image in a vertical direction, if the aspect ratio of the received video image is substantially similar to a predetermined aspect ratio of the display. The method then places the video image at either (1) a top portion of the display, or (2) a bottom portion of the display. The closed caption data is positioned at an opposing respective bottom portion of the display or a top portion of the display.

In yet another embodiment of the invention, the method receives a video image and closed caption data, and receives an aspect ratio of the received video image. The method determines a width dimension of the display and a width dimension of the video image, if the received aspect ratio of the received video image is different from the predetermined aspect ratio of the display. The video image is resized to fit the width dimension of the display, if the received width dimension of the video image is wider than the width dimension of the display. The resized video image is placed at either (1) a top portion of the display or (2) a bottom portion of the display. The closed caption data is then positioned at an opposing respective bottom portion of the display or a top portion of the display.

In still another embodiment of the invention, the method receives a video image and closed caption data, and receives an aspect ratio of the received video image. The method determines a width dimension of the display and a width dimension of the video image, if the received aspect ratio of the received video image is different from the predetermined aspect ratio of the display. The video image is resized to fit a vertical dimension of the display, if the determined width dimension of the video image is smaller than the width dimension of the display. The resized video image is placed at either (1) a left portion of the display or (2) a right portion of the display. The closed caption data is positioned at an opposing respective right portion of the display or a left portion of the display.

It is understood that the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is a functional block diagram of a video receiving system operable to execute decoding and formatting of video data and auxiliary data in accordance with an embodiment of the invention;

FIGS. 2(a)-2(f) illustrate examples of screens, each displaying a video image area and a closed caption text area, in which the image area and text area are disposed side-by-side in accordance with a method of the invention;

FIG. 3 is a flow diagram of a setup method in accordance with an embodiment of the invention; and

FIGS. 4(a)-4(b) illustrate a flow diagram of a method of displaying an image and closed caption data in accordance with an exemplary embodiment of the invention.

### DETAILED DESCRIPTION OF THE INVENTION

The present invention may be used with closed caption text, subtitles text or other information that is received for display with the video program. In the description that follows, this information is referred to generically as caption text (or data). Although the invention is described below with reference to closed caption data, it is contemplated that it may be practiced with other types of caption data.

As described below, the method of the invention includes a closed captioning override method implemented at the viewer's receiver. When activated, the method removes positioning and text formatting of the received data. The data may be displayed in a text window defined by the viewer (user), or may be displayed in one of several preset window options available to the viewer through a setup menu. Text decay rate (the rate at which text is removed from the television screen, when not otherwise replaced with new text) may also be programmable by the viewer. Decay rate options, as well as number of lines of text to be displayed with scrolling options, may be selected by the viewer. Font style and size may also be viewer selectable.

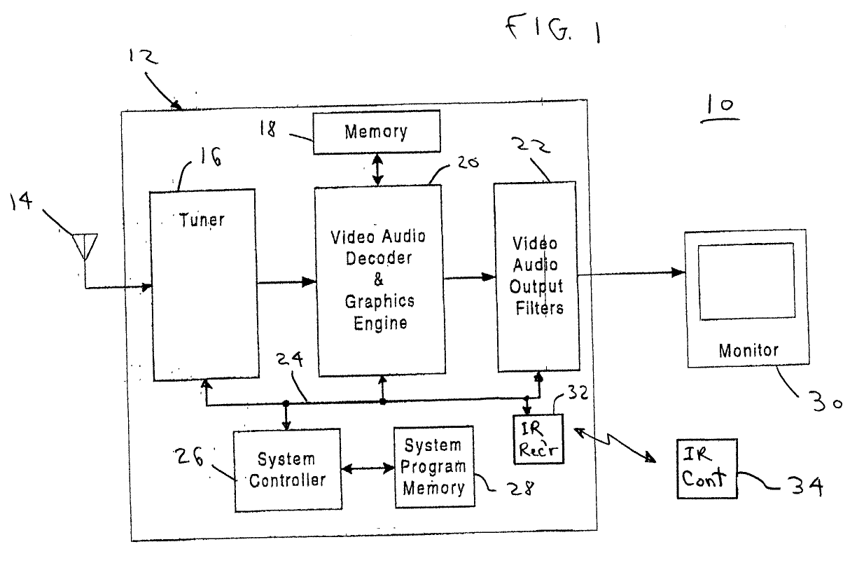

Turning now to FIG. 1, there is shown a functional block diagram of system 10 operable to execute decoding of video and closed caption data according to the present invention. Shown are receiver 12 and monitor 30. Receiver 12 may be, for example, a set top box and monitor 30 may be, for example, a standard television display.

Receiver 12 includes television tuner 16 receiving a television signal from antenna 14. The received signal may include an NTSC broadcast television signal, an ATSC (Advanced Television Standards Committee) broadcast television signal, a digital cable signal or a satellite signal. Video-audio decoder and graphics engine 20 converts the television signal into video, audio and data signals. The signals, formatted digitally, as video images and data, may be stored in memory 18. The graphics engine may access the video images and data in the memory, format the images and data, and send them to monitor 30. Prior to display, the video images and data may be filtered by video-audio output filters 22.

As shown, system controller 26 is connected to tuner 16, decoder and graphics engine 20, output filters 22 and infrared (IR) receiver 32, by way of controller bus 24. System controller 26 executes a program, resident in system program memory 28, to control operation of the respective components in receiver 12. IR receiver 32 permits a user to control operation of system 10 by being receptive to IR signals transmitted from user remote control 34.

In the arrangement shown in FIG. 1, when a video signal containing closed caption data is received, the system controller and graphics engine are responsible for separating the video image from the closed caption data. The video images are decoded and temporarily stored in memory. The closed caption data are also decoded and stored in memory. Because the video image and the closed caption data are stored in separate buffers (not shown) of the memory, they may be separately manipulated by the method of the invention.

The system controller and graphics engine may adjust each video image into an appropriate size for display. The image may be filtered in the vertical and horizontal directions to reduce the image size. For example, lines (verticality) or pixels (horizontality) may be skipped at predetermined intervals to scale down the image in size. The image may be increased in size by interpolating lines (verticality) or pixels (horizontality) at predetermined intervals. The image may be displayed, of-course, without modification. An exemplary system for filtering a video image in the horizontal and vertical directions is described in U.S. Pat. No. 6,175,592, entitled “Frequency Domain Filtering for Down Conversion of a DCT Encoded Picture”, which is incorporated herein by reference for its teaching on image filtering.

The outline or border of the resulting image may be placed horizontally at the left or right of the display and/or placed vertically at the top or bottom of the display. The image border may also be displayed on the entire screen, without special horizontal or vertical placement.

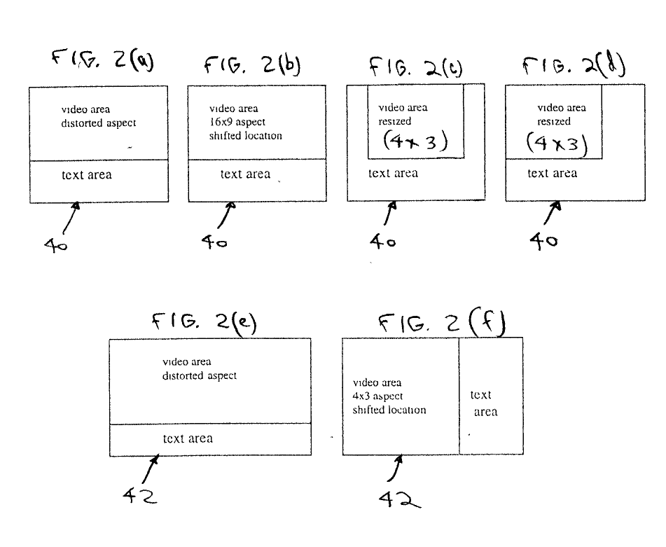

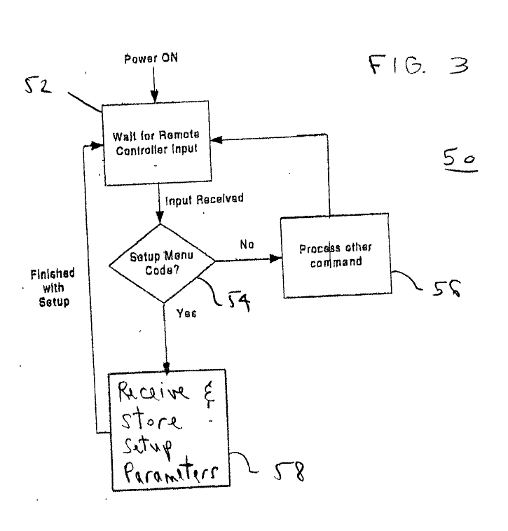

FIGS. 2(a)-2(f) illustrate examples of the display screen, when closed caption data is displayed along the side of the image, using the method of the invention. FIGS. 2(a)-2(d) illustrate display 40 with a 4×3 aspect ratio and FIGS. 2(e)-2(f) illustrate display 42 with a 16×9 aspect ratio. The 4×3 aspect ratio is the standard television picture aspect ratio used in NTSC, PAL and SECAM television systems. The 16×9 aspect ratio is the next generation picture television used in HDTV and DVD television systems.

If the received video signal has a 4×3 aspect ratio, then it may be displayed on display 40 without distortion. If the viewer, however, desires to place closed caption data on the bottom of display 40, for example, the method of the invention is adapted to vertically filter the video signal and produce a vertically smaller image, as shown in FIG. 2(a). The video image area is vertically distorted to occupy fewer lines on display 40. The remaining lines on display 40 may be used to display the closed caption data, as shown by the text area in FIG. 2(a).

Alternatively, the active video area may be moved to the bottom of the display, so that the lower border of the active video area is adjacent to the lowest display line of display 40. In this manner, the text area may be placed above the video area (in other words, the text area and video area shown in FIG. 2(a) are reversed in vertical relationship).

In the embodiment of the invention illustrated in FIG. 2(a), the closed caption data advantageously do not obscure the active video image. Because the active image is distorted in the vertical direction to occupy fewer lines, and because the closed caption data are decoded and placed in display lines not occupied by the active video image, the user may view the active video and the closed caption data, side-by-side, without the caption data obstructing the image.

Another embodiment of the invention is shown in FIG. 2(b). In this embodiment, the received video signal may be converted into an active video image having a 16×9 aspect ratio. Alternatively, the received video signal may have a 16×9 aspect ratio, but may be resized to fit display 40, while maintaining the 16×9 aspect ratio. In this manner, an area of display 40 is left unoccupied with the active video image. When the active video image is placed at the top of display 40, as shown in FIG. 2(b), the bottom area may be used for closed captioning text. When the active video image is placed at the bottom of display 40 (not shown), the top of display 40 may be used for the closed caption text.

A further embodiment of the invention is shown in FIGS. 2(c) and 2(d). As shown, the received video signal may be resized, without distortion, to maintain a 4×3 aspect ratio. The received video signal (4×3 aspect ratio) is filtered in the vertical and horizontal directions to proportionately reduce the size of the active video image.

In FIG. 2(c) the resized 4×3 video image is shown at the top-center of display 40, whereas in FIG. 2(d) the resized video image is shown placed at the top-left of display 40. Although not shown, the resized 4×3 video image may be placed at the top-right of display 40, the bottom-left of display 40, the bottom-center of display 40, or the bottom-right of display 40. The closed caption text may be displayed in the text area at the bottom of display 40. Alternatively, if the resized 4×3 video image is placed at the bottom of display 40, the text area may be located at the top of display 40 (not shown).

FIGS. 2(e) and 2(f) illustrate embodiments of the invention in which the received video image may be distorted in aspect ratio or shifted in location on display 42. As shown, display 42 is a wide screen display, such as a display having a 16×9 aspect ratio. If the received video signal has a 16×9 aspect ratio, then the image may be displayed on display 42 without distortion.

If the viewer, however, desires to place closed caption data at the bottom of display 42, for example, the method of the invention is adapted to vertically filter the video signal and produce a vertically smaller image, as shown in FIG. 2(e). The video image area may be vertically distorted to occupy fewer lines on display 42. The remaining lines on display 42 may be used to display the closed caption data, shown as text area in FIG. 2(e).

Alternatively, the active video area may be moved to the bottom of the display, so that the lower border of the active video area is adjacent to the lowest display line of display 42. In this manner, the text area may be placed above the video image area (not shown).

In the embodiment of FIG. 2(f), the received video image, having a 4×3 aspect ratio, may be displayed without distortion by maintaining the 4×3 aspect ratio on wide screen display 42. The 4×3 video image is shown shifted to the left of display 42. The closed caption data may be placed to the right of the 4×3 video image in the text area of FIG. 2(f). Alternatively, the 4×3 video image may be shifted to the right of display 42, and the closed caption data may be placed to the left of the 4×3 video image (not shown).

FIG. 3 depicts a flow diagram of a setup method in accordance with an embodiment of the invention. While the setup method is described in terms of a closed caption display, it is applicable to displays of other types of auxiliary information, for example, subtitles or weather alerts issued by the National Oceanic and Atmospheric Administration (NOAA). The setup method, generally designated as 50, may be executed by system controller 26 (FIG. 1) and may reside in system program memory 28. As shown, after power ON, the method waits in step 52 for the setup menu to be activated. The setup menu may be activated, for example, by a user through IR controller 34. So long as the setup menu is not activated, as determined by decision box 54, the method permits other control commands to be processed upon branching to step 56. Other control commands may include, for example, selecting a frequency channel for viewing a program or raising the volume of the audio, etc. If the setup menu code is detected, however, by IR receiver 32 (for example), decision box 54 branches to step 58 to begin receiving and storing setup parameters.

The setup parameters, for example, may include items listed in the table below.

Table of Exemplary Setup Parameters

| | |
|---|---|
| Horizontal Placement | Left or Right |
| Preference: | |
| Vertical Placement | Top or bottom |
| Preference: | |
| CC Style: | Normal or Off-Image or |
| | OFF |
| Monitor Aspect Ratio: | 4 × 3 or 16 × 9 |
| Aspect Ratio User Setting: | Maintain or Distort |

The horizontal placement preference provides an option to the user to select placement of the active video image either at the “left” or “right” of the display (for example, FIG. 2(f) shows the image placed at the left of display 42).

The vertical placement preference provides an option to the user to select placement of the active video image either at the “top” or “bottom” of the display (for example, FIG. 2(b) shows the image placed at the top of display 40).

The closed caption (CC) style permits the user to select “normal” captioning, in which CC text is presented on the display in a conventional manner. Alternatively, the CC style permits the user to select “off-image”, in which CC text is presented on the display in a non-active video image region (area), as shown, for example, in FIGS. 2(a)-2(f). If CC text is not desired by the user, selection of “off” for CC style is also available.

In the setup mode, the user may select a monitor aspect ratio of 4×3 or 16×9, for example, as shown in the table. The user may also select to “maintain” or to “distort” the received active video image. In this manner, the invention may “maintain” the aspect ratio of the image without distortion. For example, a received image having a 4×3 aspect ratio may be maintained without distortion on display 42, as shown in FIG. 2(f). As another example, a received image having a 4×3 aspect ratio may be maintained without distortion on display 40 by proportionately reducing the size of the image, as shown in FIGS. 2(c) and 2(d).

Alternatively, the invention may “distort” the aspect ratio of the received image. For example, a received video image having a 4×3 aspect ratio may be distorted vertically to permit CC text to be placed at the bottom of display 40, as shown in FIG. 2(a). As another example, a received video image having a 16×9 aspect ratio may be distorted vertically to permit CC text to be placed at the bottom of display 42.

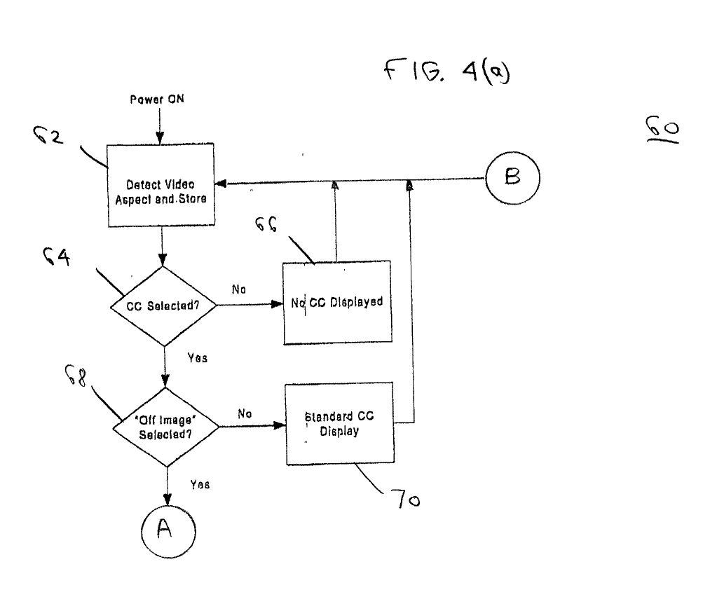

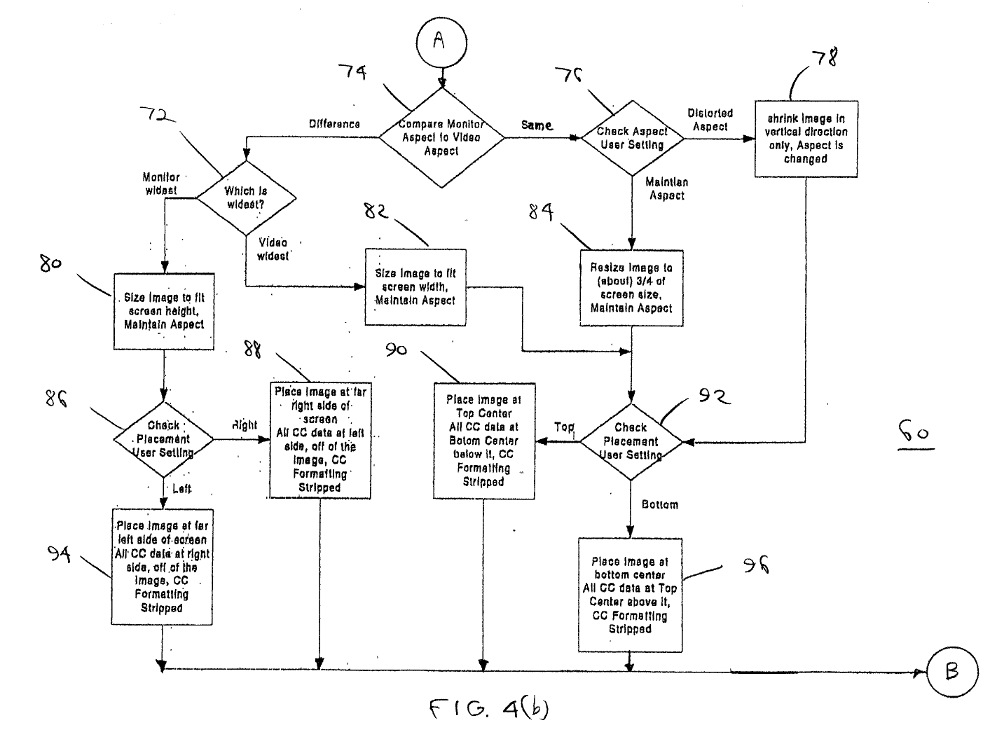

Referring next to FIGS. 4(a)-4(b), there is shown a flow diagram of a method of displaying an image and CC text, in accordance with an exemplary embodiment of the invention. The method, generally designated as 60, may be executed by system controller 26 (FIG. 1) and may reside in system program memory 28.

After power ON, the method decodes the received video signal and stores the decoded signal as video frames or fields in memory 18. As shown, step 62 detects the aspect ratio of the received video image and stores the aspect ratio in memory. The method then enters decision box 64 and determines whether “CC” is selected by the user. If not selected, the method branches to step 66, without activating CC data decoding, and only displays the video image. If “CC” is selected, the method branches to decision box 68 and determines whether “off image” is selected. If “off image” is not selected, the method branches to step 70 and displays the CC text superimposed on the video image, in a conventional manner.

If decision box 68 determines that “CC” is selected, the method branches to decision box 74. The monitor aspect ratio (as selected by the user during execution of the setup routine of FIG. 3) is compared to the received video aspect ratio. If both aspect ratios are similar, the method branches to the right in FIG. 4(b) and enters decision box 76. If both aspect ratios are different, however, the method branches to the left in FIG. 4(b) and enters decision box 72.

Assuming that the monitor aspect ratio and the received video aspect ratio are similar, decision box 76 checks the aspect ratio user setting (see table) for selection of “distort” or “maintain”. If “distort” is selected, step 78 shrinks the received video image in the vertical direction only, thereby distorting the aspect ratio. The method then enters decision box 92 and determines the vertical preferences selected by the user (see table).

If “top” is selected, the method enters step 90 and places the active image at the top center of the display, as shown in FIGS. 2(a) and 2(e). The CC text is placed at the bottom center of the display. The CC formatting is stripped. If “bottom” is selected, however, the method enters step 96 and places the active image at the bottom center of the display (not shown). The CC text is then placed at the top center of the display.

Returning to decision box 76, if the user selects “maintain”, the method enters step 84 and reduces the size of the active image by approximately ¾ of the display size. In this manner, the aspect ratio of the image is maintained on the display, for example, as shown in FIGS. 2(c) and 2(d).

After resizing the active image in step 84, decision box 92 is entered. As previously described, the method checks whether the placement preference is “top” or “bottom” and branches either to step 90 or step 96. If “top” is selected, CC text is placed at the bottom of the display and below the active video image, as shown in FIGS. 2(c) and 2(d). If “bottom” is selected, CC text is placed at the top of the display and above the active video image (not shown). The method then loops back to step 62 and continues monitoring for changes.

Referring again to decision box 74, the method compares the monitor aspect ratio to the video aspect ratio. If the aspect ratios are different, the method branches to decision box 72 and determines which aspect ratio (monitor or video) is wider. If the video image is wider, the method enters step 82 and resizes the video image to fit the display width. By proportionately reducing both the width and height of the active video image, the aspect ratio of the image may be maintained. This embodiment is illustrated in FIG. 2(b). As shown, the received video image includes an aspect ratio of 16×9, which is of a wider image than the width of display 40 (4×3 aspect ratio). By reducing the width of the image to fit display 40 and by proportionately reducing the height of the image, the 16×9 aspect ratio of the image may be maintained. As a result of the reduction in the height of the image, display 40 may display CC text without obstructing the image.

From step 82, the method enters decision box 92 and places the image either at the top of the display or at the bottom of the display (steps 90 and 96). FIG. 2(b) illustrates the image at the top of display 40 and the CC text at the bottom of display 40.

Returning to decision box 72, if the method determines that the monitor is wider than the width of the received video, the method enters step 80. The received video is resized to fit the screen height. By resizing the height of the image and proportionately modifying the width of the image, the aspect ratio of the video signal may be maintained. The method then enters decision box 86 to determine whether the horizontal placement preference of the user is “left” or “right” (see table). If “left” is selected during setup, the method enters step 94 and places the active image at the left side of the display This embodiment is illustrated in FIG. 2(f), showing CC text placed at the right side of the display.

If “right” is selected, however, the method enters step 88 and places the image at the right side of the display and the CC data at the left side of the display (reverse of video area and text area shown in FIG. 2(f)).

It will be appreciated that in the described embodiments, the method of the invention places the active video at one location on the display, and the CC text at a different location (non-interfering location) on the display. In this manner, the user may advantageously place the received image and the CC text at any desired location, and may view each without obstruction.

The CC text may be presented on the screen with user selectable decay rates, number of text lines, and scrolled/painted-on/popped-on options.

Although illustrated and described herein with reference to certain specific embodiments, the present invention is nevertheless not intended to be limited to the details shown. Rather, various modifications may be made in the details within the scope and range of equivalents and without departing from the spirit of the invention. For example, video signals having an aspect ratio other than 4×3 or 16×9 may be resized (enlarged or reduced) and fitted for display on a monitor having other than a 4×3 or 16×9 aspect ratio.

What is claimed:

1. A method of providing auxiliary data on a display, comprising the steps of:
(a) receiving a video signal;
(b) extracting from the video signal auxiliary data and storing the extracted auxiliary data;
(c) extracting from the video signal a video image, and storing the extracted video image;
(d) manipulating the video image to adjust a least one of a horizontal dimension and a vertical dimension;
(e) positioning the manipulated video image on the display; and
(f) positioning the auxiliary data on the display adjacent to the positioned video image.

2. The method of claim 1 in which
step (d) includes proportionately reducing the size of the video image in size in the horizontal dimension and in the vertical dimension;
step (e) includes positioning the reduced sized image to a side of the display; and
step (f) includes positioning the auxiliary data to another side of the display.

3. The method of claim 2 in which the reduced sized image is positioned on a top side of the display and the auxiliary data is positioned on a bottom side of the display.

4. The method of claim 2 in which the reduced sized image is positioned on a bottom side of the display and the auxiliary data is positioned on a top side of the display.

5. The method of claim 1 in which
step (a) includes receiving the video signal having a predetermined aspect ratio; and
step (d) includes proportionately reducing the size of the video image to an aspect ratio substantially similar to the predetermined aspect ratio.

6. The method of claim 5 in which the predetermined aspect ratio is 4×3.

7. The method of claim 1 in which
step (d) includes distorting the video image in the vertical dimension to reduce the video image in size;
step (e) includes positioning the distorted image to a side of the display; and
step (f) includes positioning the auxiliary data to another side of the display.

8. The method of claim 7 in which the distorted image is positioned on a top side of the display and the auxiliary data is positioned on a bottom side of the display.

9. The method of claim 7 in which the distorted image is positioned on a bottom side of the display and the auxiliary data is positioned on a top side of the display.

10. The method of claim 1 in which the display has a 4×3 aspect ratio, and in which
step (a) includes receiving a video signal having a 16×9 aspect ratio;
step (d) includes reducing the video image in the horizontal dimension to fit a horizontal dimension of the display, and proportionately reducing the video image in the vertical dimension to substantially maintain the 16×9 aspect ratio of the video image;
step (e) includes positioning the video image on the display to one of (1) a top side of the display and (2) to a bottom side of the display; and
step (f) includes positioning the auxiliary data to an opposing respective bottom side of the display or top side of the display.

11. The method of claim 1 in which the display includes a 16×9 aspect ratio, and in which
step (a) includes receiving a video signal having a 4×3 aspect ratio;
step (d) includes enlarging the video image in the vertical dimension to fit a vertical dimension of the display, and proportionately enlarging the video image in the horizontal dimension to substantially maintain the 4×3 aspect ratio of the video image;
step (e) includes positioning the video image on the display to one of (1) a left side of the display and (2) to a right side of the display; and
step (f) includes positioning the auxiliary data to an opposing respective right side of the display or left side of the display.

12. The method of claim 1 further including the steps of:
receiving a selection of an aspect ratio of the display;
receiving a selection of an aspect ratio of the received video image; and
step (d) includes manipulating the video image in size to occupy a first portion of the display; and
step (f) includes positioning the auxiliary data on a second portion of the display, in which the first and second portion are disposed side-by-side on the display.

13. The method of claim 12 further including the steps of:
receiving a selection of “off-image” for the display; and
step (f) includes positioning the auxiliary data in response to the selection of “off-image”.

14. A method of providing closed caption data on a display having a predetermined aspect ratio, comprising the steps of:
(a) receiving a video image and closed caption data;
(b) determining an aspect ratio of the received video image;
(c) shrinking the video image in a vertical dimension, if the determined aspect ratio of the received video image is substantially similar to the predetermined aspect ratio of the display;
(d) placing the video image at one of (1) a top portion of the display and (2) a bottom portion of the display; and
(e) positioning the closed caption data at an opposing respective bottom portion of the display or a top portion of the display.

15. The method of claim 14 including the step of:
receiving a selection of “maintain aspect ratio”; and
step (c) includes shrinking the video image in a horizontal dimension in addition to the vertical dimension, if “maintain aspect ratio” is selected.

16. A method of providing closed caption data on a display having a predetermined aspect ratio, comprising the steps of:
(a) receiving a video image and closed caption data;
(b) determining an aspect ratio of the received video image;
(c) determining a width dimension of the display and a width dimension of the video image, if the determined aspect ratio of the received video image is different than the predetermined aspect ratio of the display;
(d) resizing the video image in the width dimension to fit the width dimension of the display, if the determined width dimension of the video image is wider than the width dimension of the display;
(e) placing the resized video image at one of (1) a top portion of the display and (2) a bottom portion of the display; and
(f) positioning the closed caption data at an opposing respective bottom portion of the display or a top portion of the display.

17. A method of providing closed caption data on a display having a predetermined aspect ratio, comprising the steps of:
(a) receiving a video image and closed caption data;
(b) determining an aspect ratio of the received video image;
(c) determining a width dimension of the display and a width dimension of the video image, if the determined aspect ratio of the received video image is different than the predetermined aspect ratio of the display;
(d) resizing a height dimension the video image to fit a height dimension of the display, if the determined width dimension of the video image is smaller than the width dimension of the display;
(e) placing the resized video image at one of (1) a left portion of the display and (2) a right portion of the display; and
(f) positioning the closed caption data at an opposing respective right portion of the display or a left portion of the display.
